(19) United States
(12) Patent Application Publication
(10) Pub. No.: US 2024/0375849 A1
(43) Pub. Date: Nov. 14, 2024

(54) Illuminated Candy Dispenser Assembly

(71) Applicant: Travio Ward, Harker Heights, TX (US)

(72) Inventor: Travio Ward, Harker Heights, TX (US)

(21) Appl. No.: 18/195,214

(22) Filed: May 9, 2023

(51) Int. Cl. B65D 83/04; G07F 11/44

(52) U.S. Cl. CPC B65D 83/0418; G07F 11/44; B65D 2583/0427

(57) ABSTRACT

An illuminated candy dispenser assembly includes a candy dispenser that has a plurality of compartments each integrated into the candy dispenser to contain candy. A cup holder is coupled to the candy dispenser to contain a plurality of cups that is each removable from the cup holder for holding the candy that is dispensed from the candy dispenser. A pole is coupled to and extends downwardly from the candy dispenser and the pole is comprised of a translucent material to pass light through the pole. A base engages the pole and the base rests on a support surface. A plurality of light emitters is provided and each of the light emitters is positioned within the pole to emit light outwardly through the pole when the light emitters are turned on.

### CROSS-REFERENCE TO RELATED APPLICATIONS

Not Applicable.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable.

### STATEMENT REGARDING PRIOR DISCLOSURES BY THE INVENTOR OR JOINT INVENTOR

Not Applicable.

### BACKGROUND OF THE INVENTION

### (1) Field of the Invention

The disclosure relates to dispenser devices and more particularly pertains to a new dispenser device for dispensing candy. The device includes a candy dispenser, a pole extending downwardly from the candy dispenser and a base attached to the pole. The pole is comprised of a translucent material and a plurality of light emitters is positioned in the pole. A power switch is positioned on the base for turning the light emitters on and off.

### (2) Description of Related Art Including Information Disclosed Under 37 CFR 1.97 and 1.98

The prior art relates to dispenser devices including a variety of coin operated dispensing devices for dispensing a measured amount of candy. The prior art discloses a variety of containers, each being comprised of a translucent material and which each includes light emitters for emitting light outwardly from the containers. The prior art discloses a candy dispenser which as a transparent globe and a light emitting element integrated into the transparent globe. The prior art discloses a candy dispenser which includes a transparent tube and a twisted chute positioned inside of the transparent tube to dispense candy. The prior art discloses a variety of ornamental designs for candy dispensers which each has at least one transparent structural element.

### BRIEF SUMMARY OF THE INVENTION

An embodiment of the disclosure meets the needs presented above by generally comprising a candy dispenser that has a plurality of compartments each integrated into the candy dispenser to contain candy. A cup holder is coupled to the candy dispenser to contain a plurality of cups that is each removable from the cup holder for holding the candy that is dispensed from the candy dispenser. A pole is coupled to and extends downwardly from the candy dispenser and the pole is comprised of a translucent material to pass light through the pole. A base engages the pole and the base rests on a support surface. A plurality of light emitters is provided and each of the light emitters is positioned within the pole to emit light outwardly through the pole when the light emitters are turned on.

There has thus been outlined, rather broadly, the more important features of the disclosure in order that the detailed description thereof that follows may be better understood, and in order that the present contribution to the art may be better appreciated.

There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of an illuminated candy dispenser assembly according to an embodiment of the disclosure.

FIG. 2 is a front view of an embodiment of the disclosure.

FIG. 3 is a left side view of an embodiment of the disclosure.

FIG. 4 is a back view of an embodiment of the disclosure.

FIG. 5 is a cross sectional view taken along line 5-5 of FIG. 4 of an embodiment of the disclosure.

### DETAILED DESCRIPTION OF THE INVENTION

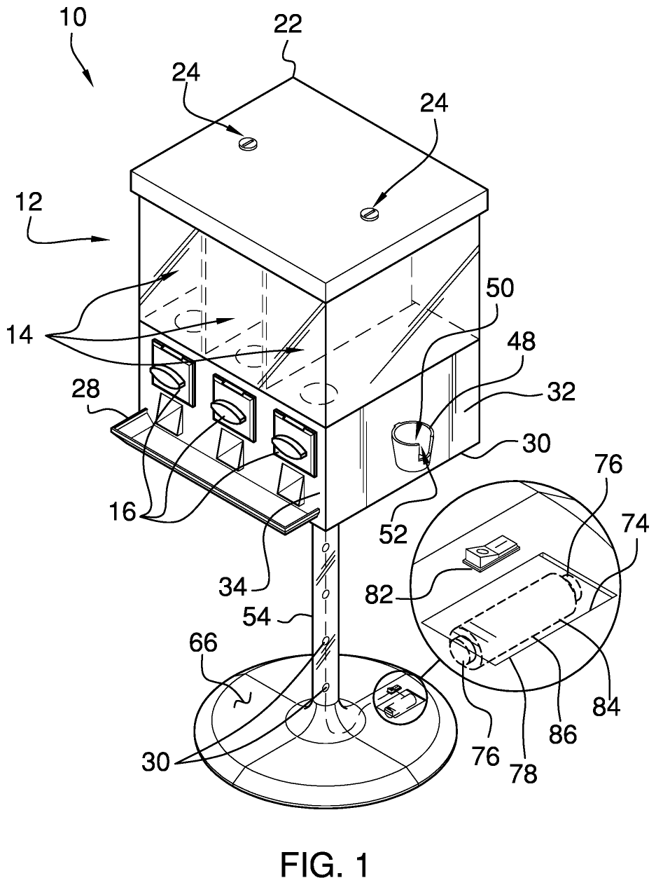

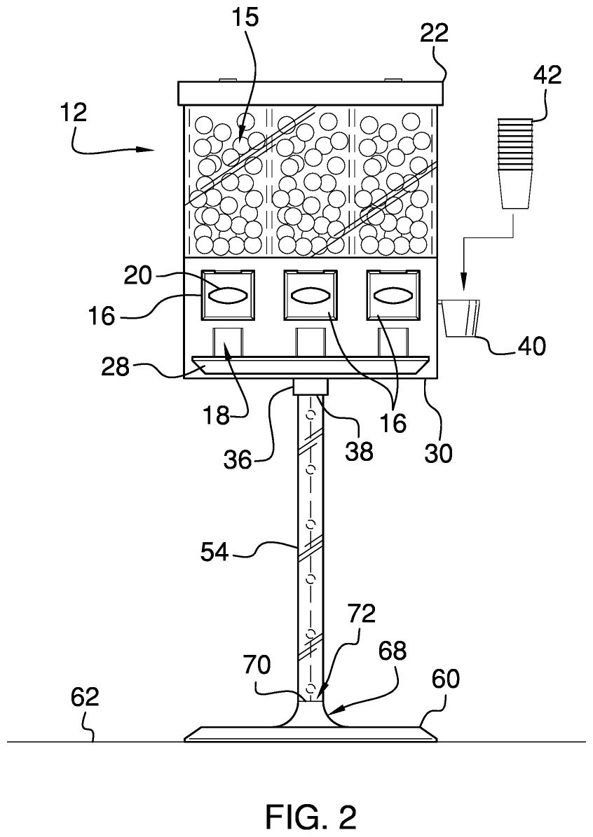

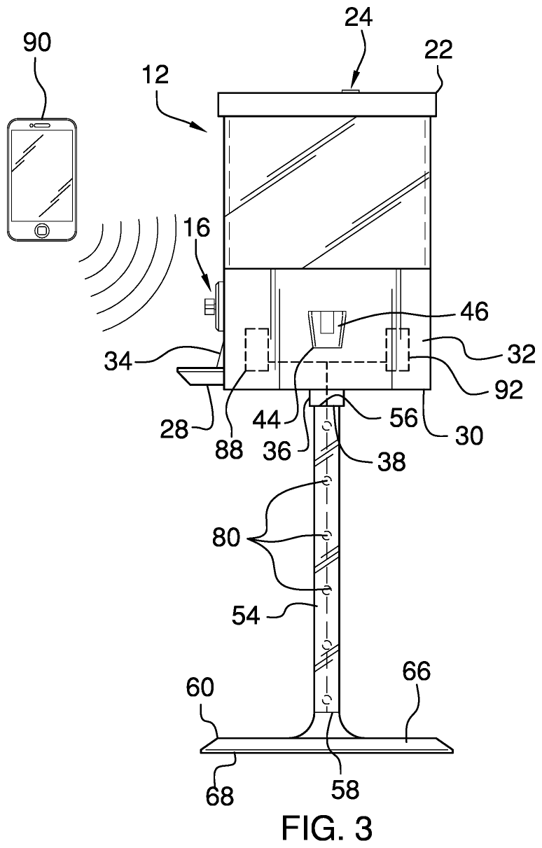

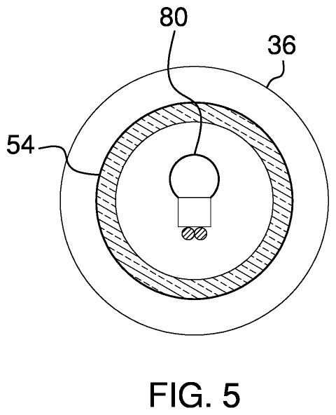

With reference now to the drawings, and in particular to FIGS. 1 through 5 thereof, a new dispenser device embodying the principles and concepts of an embodiment of the disclosure and generally designated by the reference numeral 10 will be described.

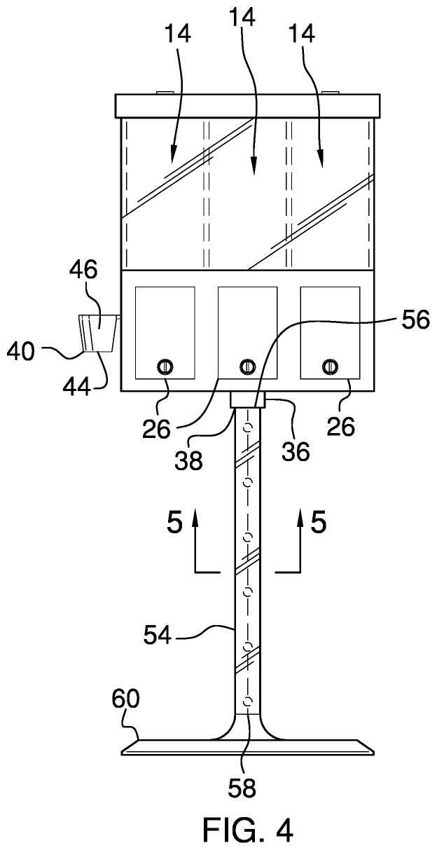

As best illustrated in FIGS. 1 through 5, the illuminated candy dispenser assembly 10 generally comprises a candy dispenser 12 which has a plurality of compartments 14 each being integrated into the candy dispenser 12 to contain candy 15. The candy dispenser 12 has a plurality of coin operated dispensing units 16 each being integrated into the candy dispenser 12. Each of the coin operated dispensing units 16 is aligned with a respective one of the compartments 14. Additionally, each of the coin operated dispensing units 16 includes a chute 18 and a knob 20 and each of the coin operated dispensing units 16 dispenses a pre-determined amount of candy 15 outwardly through the chute 18 when a coin is inserted into the coin operated dispensing units 16 and the knob 20 is rotated. Each of the coin operated dispensing units 16 may comprise a coin operated dispensing unit of any conventional design and the candy dispenser 12 includes structural elements common to candy dispensers, including a lid 22 and locks 24 in the lid 22 for locking the lid 22 on the candy dispenser 12. Additionally, as is most clearly shown in FIG. 4, the candy dispenser 12 may include a plurality of access doors 26 that is each aligned with a respective one of the coin operated dispensing units 16 for removing coins from the coin operated dispensing units 16.

The candy dispenser 12 has a tray 28 extending beneath the chute 18 of each of the coin operated dispensing units 16 to capture the candy 15 dispensed from the chute 18. The candy dispenser 12 has a bottom wall 30, a first lateral wall 32 and a front wall 34. Each of the coin operated dispensing units 16 is integrated into the front wall 34 and the tray 28 is positioned on the front wall 34. The dispenser 12 has a receiver 36 extending downwardly from the bottom wall 30 and the receiver 36 has a distal end 38 with respect to the bottom wall 30. The distal end 38 is open and the receiver 36 is centrally positioned on the bottom wall 30.

A cup holder 40 is provided and the cup holder 40 is coupled to the candy dispenser 12 to contain a plurality of cups 42 is each removable for holding the candy 15 that is dispensed from the candy dispenser 12. The cup holder 40 has a lower wall 44 and an outer wall 46 extending upwardly from the lower wall 44, and the outer wall 46 has a distal edge 48 with respect to the lower wall 44 defining an opening 50 into the cup holder 40. The outer wall 46 has a slot 52 extending from the distal edge 48 toward the lower wall 44. The outer wall 46 is attached to the first lateral wall 32 of the candy dispenser 12 having the slot 52 being directed away from the first lateral wall 32. Additionally, the cup holder 40 is positioned proximate the bottom wall 30 of the candy dispenser 12.

A pole 54 is coupled to and extends downwardly from the candy dispenser 12. The pole 54 is comprised of a translucent material to pass light through the pole 54, and the pole 54 has an upper end 56 and a lower end 58. The upper end 56 is coupled to the bottom wall 30 of the candy dispenser 12 and the distal end 38 of the receiver 36 insertably receives the upper end 56 of the pole 54. A base 60 is provided which engages the pole 54 and the base 60 rests on a support surface 62. The base 60 has a bottom surface 64 and a top surface 66, and the top surface 66 has a curved portion 68 curving upwardly from the top surface 66. The curved portion 68 has a distal edge 70 which is continuously arcuate about a center point of the base 60 such that the distal edge 70 of the curved portion 68 defines an opening 72 into the base 60, and the opening 72 in the base 60 insertably receives the lower end 58 of the pole 54.

The top surface 66 has a battery well 74 extending into an interior of the base 60 and a plurality of contacts 76 is each integrated into the battery well 74. Each of the contacts 76 is comprised of an electrically conductive material. A battery cover 78 is removably attachable to the top surface 66 of the base 60 such that the battery cover 78 closes the battery well 74.

A plurality of light emitters 80 is each positioned within the pole 54 to emit light outwardly through the pole 54 when the light emitters 80 are turned on. The light emitters 80 are spaced apart from each other and are distributed between the upper end 56 of the pole 54 and the lower end 58 of the pole 54. Additionally, the plurality of light emitters 80 is electrically coupled to each other and the plurality of light emitters 80 is electrically coupled to the plurality of contacts 76 in the battery well 74. Each of the light emitters 80 may comprise a light emitting diode or other type of electronic light emitter, and each of the light emitters 80 may emit light in a variety of colors.

A power switch 82 is movably integrated into the base 60 and the power switch 82 can be manipulated. The power switch 82 is electrically coupled to the plurality of light emitters 80 for turning the plurality of light emitters 80 on and off. The power switch 82 is positioned between the curved portion 68 of the top surface 66 of the base 60 and a perimeter edge of the base 60, and the power switch 82 is positioned adjacent to the battery well 74. A power supply 84 is positioned in the base 60 and the power supply 84 comprises at least one battery 86 that is positioned in the battery well 74. Additionally, the at least one battery 86 is in electrical communication with each of the contacts 76 in the battery well 74.

A receiver 88 may be integrated into the candy dispenser 12 and the receiver 88 may be electrically coupled to the plurality of light emitters 80. The receiver 88 may be in wireless communication with a personal electronic device 90 for remotely controlling the light emitters 80 with the personal electronic device 90. The receiver 88 may comprise a radio frequency receiver or the like and the receiver 88 may employ Bluetooth communication protocols. Additionally, the personal electronic device 90 may comprise a smart phone or other similar type of device which has wireless communication capabilities. A plurality of speakers 92 may be integrated into the candy dispenser 12 for emitting audible sound, such as music streamed from the personal electronic device, outwardly from said candy dispenser 12.

In use, a cup 42 is removed from the cup holder 40, candy 15 is dispensed from a selected one of the coin operated dispensing units 16 and the candy 15 is positioned in the cup 42. The power switch 82 is positioned in an on position to turn on each of the light emitters 80. In this way the light emitters 80 enhance the ornamental appearance of the candy dispenser 12. The battery cover 78 is removed to facilitate replacing the at least one battery when the at least one battery is depleted.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An illuminated candy dispenser assembly for storing and dispensing a pre-determined amount of candy, said assembly comprising:
a candy dispenser having a plurality of compartments each being integrated into said candy dispenser wherein each of said compartments is configured to contain candy, said candy dispenser having a plurality of coin operated dispensing units each being integrated into said candy dispenser, each of said coin operated dispensing units being aligned with a respective one of said compartments;
a cup holder being coupled to said candy dispenser wherein said cup holder is configured to contain a plurality of cups each being removable from said cup holder for holding the candy that is dispensed from said candy dispenser;
a pole being coupled to and extending downwardly from said candy dispenser, said pole being comprised of a translucent material wherein said pole is configured to pass light through said pole;
a base engaging said pole wherein said base is configured to rest on a support surface; and
a plurality of light emitters, each of said light emitters being positioned within said pole wherein each of said light emitters is configured to emit light outwardly through said pole when said light emitters are turned on.

2. The assembly according to claim 1, wherein:
each of said coin operated dispensing units includes a chute and a knob wherein each of said coin operated dispensing units is configured to dispense a pre-determined amount of candy outwardly through said chute when a coin is inserted into said coin operated dispensing units and said knob is rotated;
said candy dispenser has a tray extending beneath said chute of each of said coin operated dispensing units wherein said tray is configured to capture the candy dispensed from said chute;
said candy dispenser has a bottom wall, a first lateral wall and a front wall, each of said coin operated dispensing units being integrated into said front wall, said tray being positioned on said front wall; and
said dispenser has a receiver extending downwardly from said bottom wall, said receiver having a distal end with respect to said bottom wall, said distal end being open, said receiver being centrally positioned on said bottom wall.

3. The assembly according to claim 2, wherein said cup holder has a lower wall and an outer wall extending upwardly from said lower wall, said outer wall having a distal edge with respect to said lower wall defining an opening into said cup holder, said outer wall having a slot extending from said distal edge toward said lower wall, said outer wall being attached to said first lateral wall of said candy dispenser having said slot being directed away from said first lateral wall, said cup holder being positioned proximate said bottom wall of said candy dispenser.

4. The assembly according to claim 2, wherein said pole has an upper end and a lower end, said upper end being coupled to said bottom wall of said candy dispenser, said distal end of said receiver insertably receiving said upper end of said pole.

5. The assembly according to claim 4, wherein:
said base has a bottom surface and a top surface, said top surface having a curved portion curving upwardly from said top surface, said curved portion having a distal edge being continuously arcuate about a center point of said base such that said distal edge defines an opening into said base, said opening insertably receiving said lower end of said pole;
said top surface has a battery well extending into an interior of said base; and
said battery well has a plurality of contacts each being integrated into said battery well, each of said contacts being comprised of an electrically conductive material.

6. The assembly according to claim 4, wherein said light emitters are spaced apart from each other and being distributed between said upper end of said pole and said lower end of said pole, said plurality of light emitters being electrically coupled to each other, said plurality of light emitters being electrically coupled to said plurality of contacts in said battery well.

7. The assembly according to claim 5, further comprising a power switch being movably integrated into said base wherein said power switch is configured to be manipulated, said power switch being electrically coupled to said plurality of light emitters for turning said plurality of light emitters on and off, said power switch being positioned between said curved portion of said top surface of said base and a perimeter edge of said base, said power switch being positioned adjacent to said battery well.

8. The assembly according to claim 5, further comprising a power supply being positioned in said base, said power supply comprising at least one battery being positioned in said battery recess, said at least one battery being in electrical communication with each of said contacts in said battery well.

9. An illuminated candy dispenser assembly for storing and dispensing a pre-determined amount of candy, said assembly comprising:
a candy dispenser having a plurality of compartments each being integrated into said candy dispenser wherein each of said compartments is configured to contain candy, said candy dispenser having a plurality of coin operated dispensing units each being integrated into said candy dispenser, each of said coin operated dispensing units being aligned with a respective one of said compartments, each of said coin operated dispensing units including a chute and a knob wherein each of said coin operated dispensing units is configured to dispense a pre-determined amount of candy outwardly through said chute when a coin is inserted into said coin operated dispensing units and said knob is rotated, said candy dispenser having a tray extending beneath said chute of each of said coin operated dispensing units wherein said tray is configured to capture the candy dispensed from said chute, said candy dispenser having a bottom wall, a first lateral wall and a front wall, each of said coin operated dispensing units being integrated into said front wall, said tray being positioned on said front wall, said dispenser having a receiver extending downwardly from said bottom wall, said receiver having a distal end with respect to said bottom wall, said distal end being open, said receiver being centrally positioned on said bottom wall;
a cup holder being coupled to said candy dispenser wherein said cup holder is configured to contain a plurality of cups each being removable for holding the candy that is dispensed from said candy dispenser, said cup holder having a lower wall and an outer wall extending upwardly from said lower wall, said outer wall having a distal edge with respect to said lower wall defining an opening into said cup holder, said outer wall having a slot extending from said distal edge toward said lower wall, said outer wall being attached to said first lateral wall of said candy dispenser having said slot being directed away from said first lateral wall, said cup holder being positioned proximate said bottom wall of said candy dispenser;
a pole being coupled to and extending downwardly from said candy dispenser, said pole being comprised of a translucent material wherein said pole is configured to pass light through said pole, said pole having an upper end and a lower end, said upper end being coupled to said bottom wall of said candy dispenser, said distal end of said receiver insertably receiving said upper end of said pole;
a base engaging said pole wherein said base is configured to rest on a support surface, said base having a bottom surface and a top surface, said top surface having a curved portion curving upwardly from said top surface, said curved portion having a distal edge being continuously arcuate about a center point of said base such that said distal edge defines an opening into said base, said opening insertably receiving said lower end of said pole, said top surface having a battery well extending into an interior of said base, said battery well having a plurality of contacts each being integrated into said battery well, each of said contacts being comprised of an electrically conductive material;
a battery cover being removably attachable to said top surface of said base such that said battery cover closes said battery well;
a plurality of light emitters, each of said light emitters being positioned within said pole wherein each of said light emitters is configured to emit light outwardly through said pole when said light emitters are turned on, said light emitters being spaced apart from each other and being distributed between said upper end of said pole and said lower end of said pole, said plurality of light emitters being electrically coupled to each other, said plurality of light emitters being electrically coupled to said plurality of contacts in said battery well;
a power switch being movably integrated into said base wherein said power switch is configured to be manipulated, said power switch being electrically coupled to said plurality of light emitters for turning said plurality of light emitters on and off, said power switch being positioned between said curved portion of said top surface of said base and a perimeter edge of said base, said power switch being positioned adjacent to said battery well; and
a power supply being positioned in said base, said power supply comprising at least one battery being positioned in said battery recess, said at least one battery being in electrical communication with each of said contacts in said battery well.
